(19) United States
(12) Patent Application Publication
(10) Pub. No.: US 2026/0177059 A1
(43) Pub. Date: Jun. 25, 2026

(54) IMPELLER FOR A FAN AND A RANGE HOOD

(71) Applicant: Whirlpool (China) Co., Ltd., Hefei (CN)

(72) Inventors: Shuwei Zhang, Hefei (CN); Hongqiang Wang, Hefei (CN); Hao Dong, Hefei (CN); Lianchao Liu, Hefei (CN)

(73) Assignee: Whirlpool (China) Co., Ltd., Hefei (CN)

(21) Appl. No.: 19/427,749

(22) Filed: Dec. 19, 2025

(30) Foreign Application Priority Data
Dec. 20, 2024 (CN) 202423168128.7

(51) Int. Cl. F04D 17/08; A47J 36/38; F04D 29/28; F24C 15/20

(52) U.S. Cl. CPC F04D 17/08; A47J 36/38; F04D 29/281; F24C 15/20

(57) ABSTRACT

An impeller with a plurality of blades that extend between a first wheel disc and a second wheel disc of the impeller can be configured for use within a centrifugal fan of a range hood. The plurality of blades of the impeller can each form a sawtooth segment that includes oblique teeth that function to reduce the effects of air resistance on the operation of the impeller and reduce the noise generated by the impeller in use. The oblique teeth of each sawtooth segment can be arranged such that the dimensions of the oblique teeth gradually decrease as the sawtooth segment extends from the first wheel disc toward the second wheel disc to further improve the functionality of the impeller.

### CROSS-REFERENCE TO RELATED APPLICATIONS

This application claims priority to Chinese Utility Model patent application No. 202423168128.7, filed on Dec. 20, 2024, entitled “IMPELLER, FAN AND RANGE HOOD,” the entire disclosure of which is hereby incorporated by reference.

### TECHNICAL FIELD

The present disclosure relates to the technical field of impellers, in particular to impellers utilized within fans and range hoods.

### BACKGROUND

A range hood can operate to purify indoor air by removing particulates produced during a cooking process. The aerodynamic performance of a fan of the range hood can, at least partially, determine the overall working performance of the range hood. A multi-wing centrifugal fan can have a high pressure coefficient, a large flow coefficient, and a low operating noise.

The structure of range hoods is gradually becoming smaller and lighter. When a multi-wing centrifugal impeller is utilized, an upward protrusion of a chassis of the impeller is arranged in order to provide space to install a drive motor of the fan. When the thickness of the range hood is reduced, the arrangement of the upward protrusion of the chassis can affect the entry of a high-speed airflow into the impeller, and the actual utilization rate of the impeller blades can decrease. Consequently, the noise produced by the fan can increase.

### SUMMARY

According to one aspect of the present disclosure, an impeller includes a first wheel disc, a second wheel disc spaced apart from the first wheel disc, wherein an outer circumference of the first wheel disc is folded away from the second wheel disc to form a first air guide reinforcement rib, a plurality of blades that extend between and interconnect the first wheel disc and the second wheel disc, wherein the plurality of blades each have a sawtooth segment that extends from the first wheel disc toward the second wheel disc and wherein each sawtooth segment has oblique teeth, a chassis that extends from the first wheel disc toward the second wheel disc, and a flange coupled to the chassis and configured to engage with a drive shaft of a motor to establish a connection between the impeller and the motor, and wherein the impeller is configured for use within a range hood.

According to another aspect of the present disclosure, an impeller includes a first wheel disc, a second wheel disc spaced apart from the first wheel disc, a plurality of blades that extend between and interconnect the first wheel disc and the second wheel disc, wherein the plurality of blades each have a sawtooth segment that extends from the first wheel disc toward the second wheel disc, and wherein each sawtooth segment has oblique teeth and is positioned closer to the first wheel disc than the second wheel disc, a chassis that extends from the first wheel disc toward the second wheel disc, and a flange coupled to the chassis and configured to engage with a drive shaft of a motor to establish a connection between the impeller and the motor.

According to another aspect of the present disclosure, an impeller includes a first wheel disc, a second wheel disc spaced apart from the first wheel disc, and a blade that extends between and interconnects the first wheel disc and the second wheel disc, wherein the blade has a sawtooth segment that extends between two-thirds and four-fifths the length of the blade, and wherein the sawtooth segment has oblique teeth that are titled relative to an impeller axis of the impeller, and wherein the impeller axis defines the centerline of the impeller.

The impeller of the present disclosure provides several advantages, including, but not limited to, the following. Since a plurality of inclined blades and a sawtooth segment is provided on the air inlet side edge of each blade of the plurality of blades of the impeller, during the operation of the impeller, the oblique teeth included in each sawtooth segment can effectively cut the high-speed airflow, thereby achieving a reduction in wind noise. When the impeller of the present disclosure is used in a centrifugal fan, the impeller can reduce the noise caused by a reduced thickness of the centrifugal fan, thereby improving the performance of the centrifugal fan.

These and other features, advantages, and objects of the present disclosure will be further understood and appreciated by those skilled in the art by reference to the following specification, claims, and appended drawings

### BRIEF DESCRIPTION OF THE DRAWINGS

FIG. 1 is a side perspective schematic structural diagram of an impeller of the present disclosure;

FIG. 2 is a cross-sectional view of the impeller illustrated in FIG. 1;

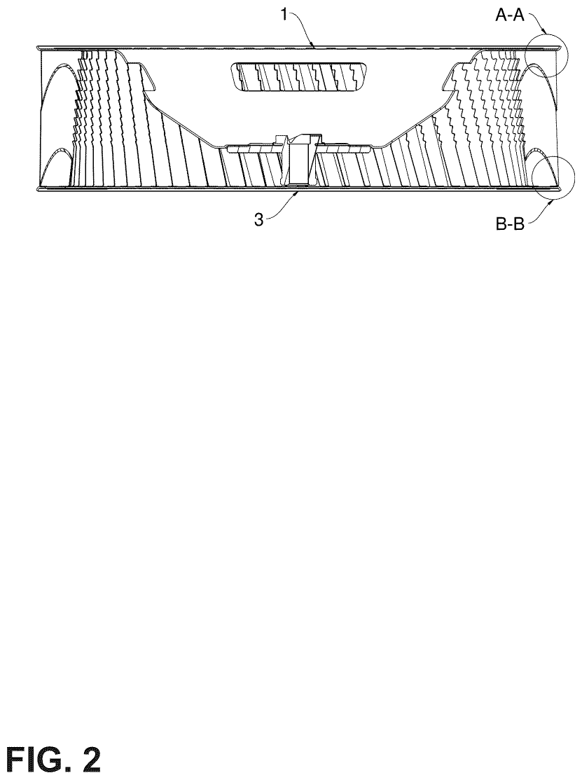

FIG. 3 is an enlarged detailed view of area A-A in FIG. 2 of a first air guide reinforcement rib of the impeller;

FIG. 4 is an enlarged detailed view of area B-B in FIG. 2 of a second air guide reinforcement rib of the impeller; and

FIG. 5 is a side elevational schematic structural diagram of a blade of the impeller of FIG. 1.

The components in the figures are not necessarily to scale, emphasis instead being placed upon illustrating the principles described herein.

### DETAILED DESCRIPTION

The present illustrated embodiments reside primarily in combinations of method steps and apparatus components related to an impeller with a plurality of blades that each form a sawtooth segment, thereby improving the operation of the impeller. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

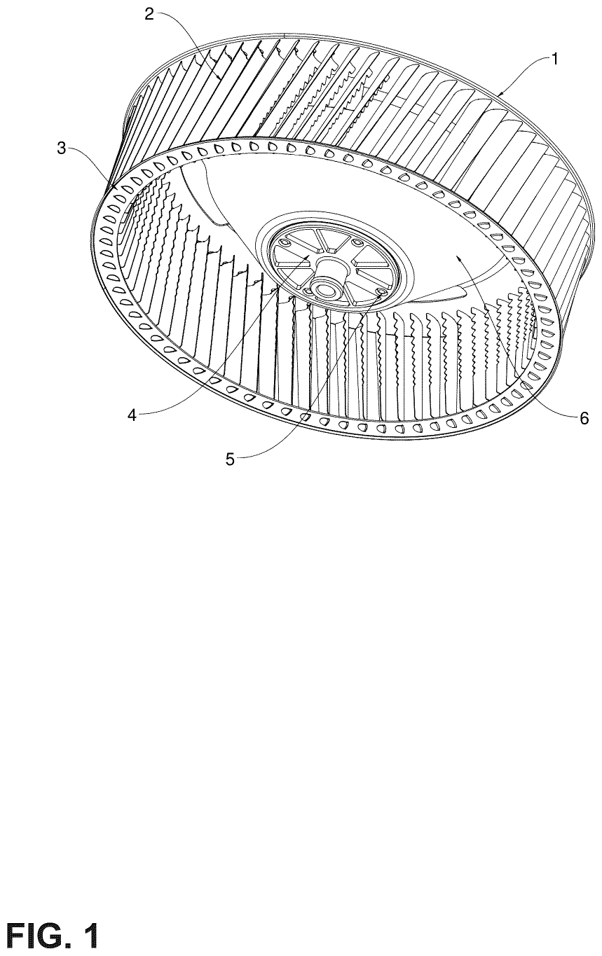

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

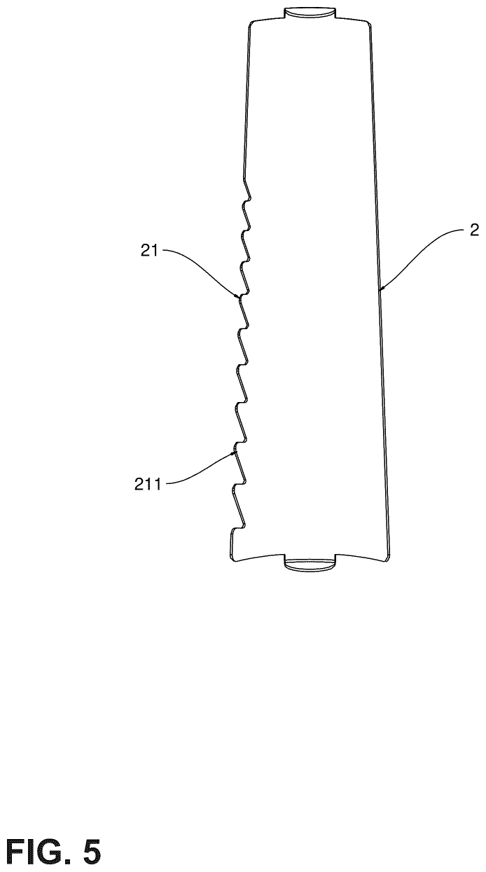

With reference to FIG. 1, an impeller proposed by the present disclosure includes a first wheel disc 1 arranged opposite a second wheel disc 3. There are a plurality of blades 2 arranged between the first wheel disc 1 and the second wheel disc 3. The plurality of blades 2 are arranged circumferentially about a perimeter of the first wheel disc 1. Additionally, the plurality of blades 2 are tilted relative to an impeller axis. As illustrated in FIGS. 1 and 5, an air inlet side edge of each of the plurality of blades 2 forms a sawtooth segment 21 that has oblique teeth 211. The first wheel disc 1 and the second wheel disc 3 rotate about the impeller axis, wherein the impeller axis defines the centerline of the impeller. As shown in FIG. 1, the plurality of blades 2 are all tilted relative to the impeller axis. The tilt of each of the plurality of blades 2 increases the effective area of each of the plurality of blades 2 and increases the air volume that can be driven by the plurality of blades 2.

As shown in FIGS. 1 and 5, the sawtooth segment 21 of each of the plurality of blades 2 is provided on the air inlet side edge of each of the plurality of blades 2. Therefore, during the operation of the impeller, the oblique teeth 211 of the sawtooth segment 21 of each blade of the plurality of blades 2 can effectively cut the high-speed airflow, thereby facilitating a reduction in wind noise.

Further, as shown in FIG. 1, the first wheel disc 1 has a chassis 6 positioned at the middle of the first wheel disc 1. The chassis 6 extends from the first wheel disc 1 toward the second wheel disc 3, such that the chassis 6 can accommodate a motor configured to drive the rotation of the impeller. Additionally, the chassis 6 is positioned within the middle of the second wheel disc 3. On one side of the chassis 6 that is positioned proximal to the second wheel disc 3, a flange 4 is fixed to the chassis 6 via fasteners 5. A drive shaft of the motor can be engaged with the flange 4 to establish a connection between the impeller and the motor. The fasteners 5 can include, but are not limited to rivets, etc.

As shown in FIG. 1, the sawtooth segment 21 of each of the plurality of blades 2 is located closer to the first wheel disc 1 than the second wheel disc 3. The length of each sawtooth segment 21 can be between two-thirds to four-fifths the length of the respective blade of the plurality of blades 2. However, the length of each sawtooth segment 21 is not limited to the above-described length.

When the impeller is assembled with the fan, the second wheel disc 3 is positioned at an air inlet end of the impeller, such that the airflow enters the impeller at the second wheel disc 3 and the airflow flows from the second wheel disc 3 and then passes through gaps defined between each of the plurality of blades 2 to discharge from the impeller. The degree of air resistance acting upon the impeller can increase from the second wheel disc 3 toward the first wheel disc 1. Accordingly, by forming a sawtooth segment 21 on the portion of each of the plurality of blades 2 that is proximal the first wheel disc 1, the heightened effects of the air resistance on the impeller that occur closer to the first wheel disc 1 can be reduced, thereby improving the overall efficiency of the impeller.

With reference to FIG. 1, each of the sawtooth segments may be the same length. For example, the sawtooth segments 21 may extend for two-thirds of the overall length of the respective blade of the plurality of blades 2. Alternatively, the length of the sawtooth segments 21 may be different. For example, along the direction of a rotation of the impeller, the length of the sawtooth segments 21 may gradually increase or, alternatively, gradually decrease.

With reference now to FIG. 5, each of the oblique teeth 211 has an asymmetric structure. Specifically, a side of each tooth of the oblique teeth 211 that faces toward the first wheel disc 1 has a greater length than a side of each tooth that faces toward the second wheel disc 3. Consequently, the air resistance produced by the airflow entering the impeller and discharged from the impeller can be reduced, and the noise generated by the impeller can thereby be reduced.

With continued reference to FIG. 5, the dimensions of the oblique teeth 211 of each sawtooth segment 21 can decrease as the sawtooth segments 21 extend from the first wheel disc 1 toward the second wheel disc 3. Specifically, the oblique teeth 211 of each sawtooth segment 21 can be arranged such that a width of a tooth root of each of the oblique teeth 211 gradually decreases as the oblique teeth 211 extend toward the second wheel disc 3. Since the air resistance produced by the airflow increases as the airflow flows along the second wheel disc 3 toward the first wheel disc 1, the stability of the impeller can be increased during operation of the impeller and wind noise can also be reduced by ordering the oblique teeth 211, such that the width of the tooth root of each of the oblique teeth 211 decreases as the oblique teeth 211 extend toward the second wheel disc 3.

With continued reference to FIG. 5, the tilt angle of each of the oblique teeth 211, relative to the impeller axis, may be between 70 degrees and 80 degrees. By forming each of the oblique teeth 211 at an angle to the impeller axis, the effective area of each of the plurality of blades 2 can be increased, thereby increasing the volume of air that the impeller is capable of moving.

With continued reference to FIG. 5, the width of each of the plurality of blades 2 can decrease, or in other words, may taper, as each of the plurality of blades 2 extends from the first wheel disc 1 to the second wheel disc 3. Tapering each of the plurality of blades 2 can provide the impeller with a greater air flow capacity while allowing for the size of the impeller air inlet to remain constant. Additionally, since the width of each of the plurality of blades 2 decreases as each of the plurality of blades 2 extends from the first wheel disc 1 toward the second wheel disc 3, and as a function of the formation of a sawtooth segment 21 by each of the plurality of blades 2 at the air inlet side edge of each of the plurality of blades 2, the production of vortices by the airflow passing through the impeller is reduced. Consequently, the noise produced by the impeller is reduced.

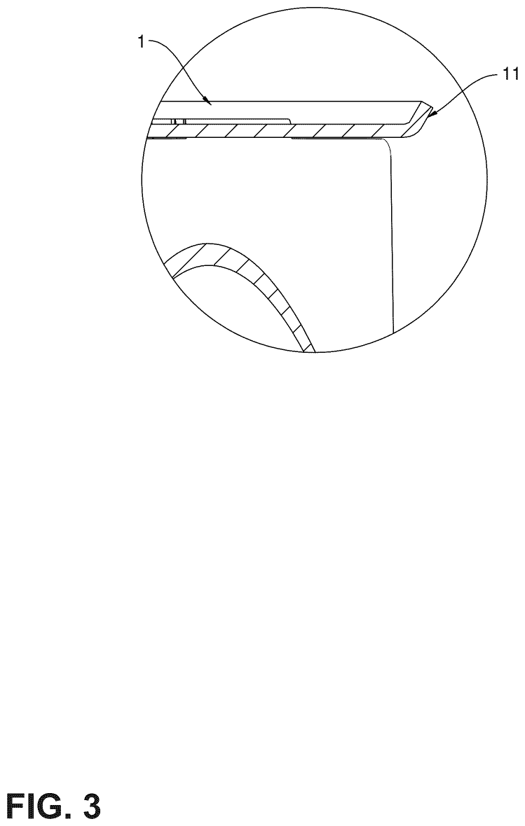

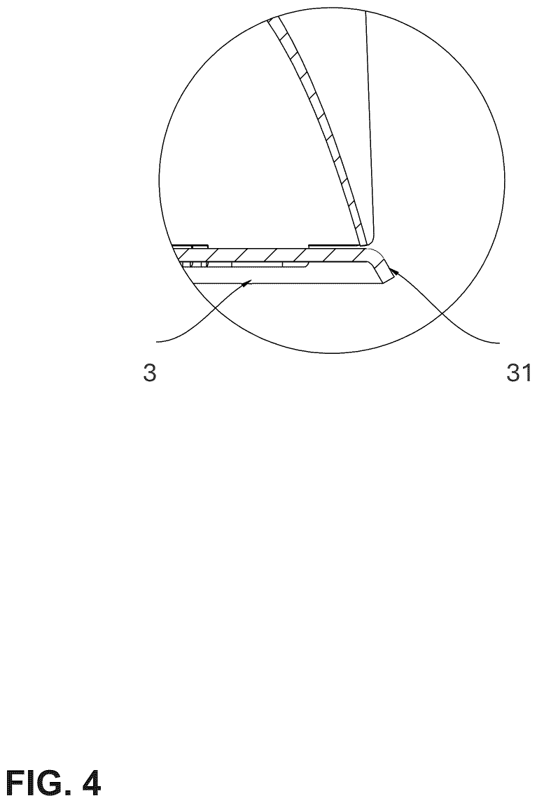

With reference now to FIGS. 3 and 4, an outer circumference of the first wheel disc 1 may be folded away from the second wheel disc 3 to form a first air guide reinforcement rib 11. An angle between the first air guide reinforcement rib 11 and the first wheel disc 1 may be between 45 degrees and 60 degrees. Additionally, as shown in FIG. 4, an outer circumference of the second wheel disc 3 may be folded away from the first wheel disc 1 to form a second air guide reinforcement rib 31. An angle between the second air guide reinforcement rib 31 and the second wheel disc 3 may be between 45 degrees and 60 degrees. The first air guide reinforcement rib 11 and the second air guide reinforcement ribs 31 may be symmetrically arranged. The first and second air guide reinforcement ribs 11, 31 can guide the airflow leaving the impeller and also can reduce the occurrence of eddy currents within the air flow, reducing noise produced by the impeller, and increasing the efficiency of the operation of the impeller. Also, both the first and second air guide reinforcement ribs 11, 31 strengthen the structure of the first wheel disc 1 and the second wheel disc 3, respectively.

The impeller may be utilized within a centrifugal fan. When the impeller is assembled onto the centrifugal fan, the second wheel disc 3 forms the air inlet of the centrifugal fan, and the chassis 6 of the first wheel disc 1 is connected to the motor drive shaft of the centrifugal fan via the flange 4. When the impeller is assembled onto the centrifugal fan, the centrifugal fan can be produced with a reduced thickness, which can improve the performance of the centrifugal fan. Additionally, the centrifugal fan with the impeller of the present disclosure can be utilized within a range hood. The range hood may be an independent range hood or an integrated range hood integrated with an integrated stove.

According to one aspect of the present disclosure, an impeller includes a first wheel disc, a second wheel disc spaced apart from the first wheel disc, wherein an outer circumference of the first wheel disc is folded away from the second wheel disc to form a first air guide reinforcement rib, a plurality of blades that extend between and interconnect the first wheel disc and the second wheel disc, wherein the plurality of blades each have a sawtooth segment that extends from the first wheel disc toward the second wheel disc and wherein each sawtooth segment has oblique teeth, a chassis that extends from the first wheel disc toward the second wheel disc, and a flange coupled to the chassis and configured to engage with a drive shaft of a motor to establish a connection between the impeller and the motor, and wherein said impeller is configured for use within a range hood.

According to another aspect, an angle between each of the oblique teeth and the impeller axis is 70 degrees.

According to another aspect, each of the sawtooth segments extends for two-thirds the length of the respective blade of the plurality of blades.

According to another aspect of the present disclosure, the oblique teeth of each sawtooth segment are arranged such that a width of a tooth root of each of the oblique teeth gradually decreases as the oblique teeth extend toward the second wheel disc.

According to yet another aspect of the present disclosure, an impeller includes a first wheel disc, a second wheel disc spaced apart from the first wheel disc, a plurality of blades that extend between and interconnect the first wheel disc and the second wheel disc, wherein the plurality of blades each have a sawtooth segment that extends from the first wheel disc toward the second wheel disc, and wherein each sawtooth segment has oblique teeth and is positioned closer to the first wheel disc than the second wheel disc, a chassis that extends from the first wheel disc toward the second wheel disc, and a flange coupled to the chassis and configured to engage with a drive shaft of a motor to establish a connection between the impeller and the motor.

According to another aspect of the present disclosure, an angle between each of the oblique teeth and an impeller axis of the impeller is 80 degrees.

According to another aspect of the present disclosure, each of the sawtooth segments extends for four-fifths the length of the respective blade of the plurality of blades.

According to another aspect of the present disclosure, an outer circumference of the first wheel disc is folded away from the second wheel disc to form a first air guide reinforcement rib, and wherein an outer circumference of the second wheel disc is folded away from the first wheel disc to form a second air guide reinforcement rib.

According to another aspect of the present disclosure, an angle between the first air guide reinforcement rib and the first wheel disc is between 45 degrees and 60 degrees, and wherein an angle between the second air guide reinforcement rib and the second wheel disc is between 45 degrees and 60 degrees.

According to yet another aspect of the present disclosure, an impeller includes a first wheel disc, a second wheel disc spaced apart from the first wheel disc, and a blade that extends between and interconnects the first wheel disc and the second wheel disc, wherein the blade has a sawtooth segment that extends between two-thirds and four-fifths the length of the blade, and wherein the sawtooth segment has oblique teeth that are tilted relative to an impeller axis of the impeller, and wherein the impeller axis defines the centerline of the impeller.

According to another aspect of the present disclosure, each of the oblique teeth of the sawtooth segment has an asymmetric structure.

According to another aspect of the present disclosure, the oblique teeth of the sawtooth segment are arranged such that the dimensions of the oblique teeth gradually decrease as the sawtooth segment extends from the first wheel disc toward the second wheel disc.

According to another aspect of the present disclosure, a side of each of the oblique teeth that faces toward the first wheel disc has a greater length than a side of each of the oblique teeth that faces toward the second wheel disc.

According to another aspect of the present disclosure, each of the oblique teeth are tilted, such that an angle between each of the oblique teeth and the impeller axis is between 70 degrees and 80 degrees.

According to another aspect of the present disclosure, the sawtooth segment of the blade is positioned closer to the first wheel disc than the second wheel disc.

According to another aspect of the present disclosure, the second wheel disc forms an air inlet end of the impeller, wherein an airflow enters the impeller through the air inlet end.

According to another aspect of the present disclosure, a width of the blade decreases as the blade extends from the first wheel disc to the second wheel disc.

According to another aspect of the present disclosure, the impeller further includes a chassis, wherein the chassis extends from the first wheel disc toward the second wheel disc to accommodate a motor configured to drive the rotation of the impeller.

According to another aspect of the present disclosure, the impeller further includes a flange, wherein the flange is fixed to the chassis and configured to engage with a drive shaft of the motor to establish a connection between the impeller and the motor.

According to another aspect, the impeller is installed within a centrifugal fan of a range hood.

1-10. (canceled)

11. An impeller, comprising:
a first wheel disc;
a second wheel disc spaced apart from the first wheel disc, wherein an outer circumference of the first wheel disc is folded away from the second wheel disc to form a first air guide reinforcement rib;
a plurality of blades that extend between and interconnect the first wheel disc and the second wheel disc, wherein the plurality of blades each have a sawtooth segment that extends from the first wheel disc toward the second wheel disc and wherein each sawtooth segment has oblique teeth;
a chassis that extends from the first wheel disc toward the second wheel disc; and
a flange coupled to the chassis and configured to engage with a drive shaft of a motor to establish a connection between the impeller and the motor, and wherein said impeller is configured for use within a range hood.

12. The impeller of claim 11, wherein an angle between each of the oblique teeth and the impeller axis is 70 degrees.

13. The impeller of claim 11, wherein each of the sawtooth segments extends for two-thirds the length of the respective blade of the plurality of blades.

14. The impeller of claim 11, wherein the oblique teeth of each sawtooth segment are arranged such that a width of a tooth root of each of the oblique teeth gradually decreases as the oblique teeth extend toward the second wheel disc.

15. An impeller, comprising:
a first wheel disc;
a second wheel disc spaced apart from the first wheel disc;
a plurality of blades that extend between and interconnect the first wheel disc and the second wheel disc, wherein the plurality of blades each have a sawtooth segment that extends from the first wheel disc toward the second wheel disc, and wherein each sawtooth segment has oblique teeth and is positioned closer to the first wheel disc than the second wheel disc;
a chassis that extends from the first wheel disc toward the second wheel disc; and
a flange coupled to the chassis and configured to engage with a drive shaft of a motor to establish a connection between the impeller and the motor.

16. The impeller of claim 15, wherein an angle between each of the oblique teeth and an impeller axis of the impeller is 80 degrees.

17. The impeller of claim 15, wherein each of the sawtooth segments extends for four-fifths the length of the respective blade of the plurality of blades.

18. The impeller of claim 15, wherein an outer circumference of the first wheel disc is folded away from the second wheel disc to form a first air guide reinforcement rib, and wherein an outer circumference of the second wheel disc is folded away from the first wheel disc to form a second air guide reinforcement rib.

19. The impeller of claim 18, wherein an angle between the first air guide reinforcement rib and the first wheel disc is between 45 degrees and 60 degrees, and wherein an angle between the second air guide reinforcement rib and the second wheel disc is between 45 degrees and 60 degrees.

20. An impeller, comprising:
a first wheel disc;
a second wheel disc spaced apart from the first wheel disc; and
a blade that extends between and interconnects the first wheel disc and the second wheel disc, wherein the blade has a sawtooth segment that extends between two-thirds and four-fifths the length of the blade, and wherein the sawtooth segment has oblique teeth that are tilted relative to an impeller axis of the impeller, and wherein the impeller axis defines the centerline of the impeller.

21. The impeller of claim 20, wherein each of the oblique teeth of the sawtooth segment has an asymmetric structure.

22. The impeller of claim 21, wherein the oblique teeth of the sawtooth segment are arranged such that the dimensions of the oblique teeth gradually decrease as the sawtooth segment extends from the first wheel disc toward the second wheel disc.

23. The impeller of claim 21, wherein a side of each of the oblique teeth that faces toward the first wheel disc has a greater length than a side of each of the oblique teeth that faces toward the second wheel disc.

24. The impeller of claim 20, wherein each of the oblique teeth are tilted, such that an angle between each of the oblique teeth and the impeller axis is between 70 degrees and 80 degrees.

25. The impeller of claim 20, wherein the sawtooth segment of the blade is positioned closer to the first wheel disc than the second wheel disc.

26. The impeller of claim 25, wherein the second wheel disc forms an air inlet end of said impeller, wherein an airflow enters said impeller through the air inlet end.

27. The impeller of claim 20, wherein a width of the blade decreases as the blade extends from the first wheel disc to the second wheel disc.

28. The impeller of claim 20, further comprising:
a chassis, wherein the chassis extends from the first wheel disc toward the second wheel disc to accommodate a motor configured to drive the rotation of said impeller.

29. The impeller of claim 28, further comprising:
a flange, wherein the flange is fixed to the chassis and configured to engage with a drive shaft of the motor to establish a connection between said impeller and the motor.

30. The impeller of claim 20, wherein said impeller is installed within a centrifugal fan of a range hood.
